(19) United States
(12) Patent Application Publication
(10) Pub. No.: US 2009/0103667 A1
(43) Pub. Date: Apr. 23, 2009

(54) Methods for Modified Signal Acquisition for OFDM Schemes

(75) Inventors: Jianxuan Du, San Jose, CA (US); Yue Chen, Fremont, CA (US); Baoguo Yang, San Jose, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/253,927

(22) Filed: Oct. 17, 2008

Related U.S. Application Data
(60) Provisional application No. 60/980,745, filed on Oct. 17, 2007.

(51) Int. Cl. H04L 27/06

(52) U.S. Cl. 375/343

(57) ABSTRACT

This invention relates to methods for determining coarse symbol timing and mode detection by using CP correlation-based techniques. In particular, this invention relates to methods for determining symbol timing, frame timing, and system mode for signal acquisition, comprising the steps of: detecting symbol timing and system mode based on cyclic prefix correlation; and determining a null symbol as a function of a pre-defined number of consecutive symbols and using said null symbol to determine frame timing.

### CROSS REFERENCE

This application claims priority from a provisional patent application entitled “Modified Signal Acquisition Sequence in DAB/T-DMB” filed on Oct. 17, 2007 and having an Application No. 60/980745. Said application is incorporated herein by reference.

### FIELD OF INVENTION

This invention relates to methods for signal acquisition of orthogonal frequency division multiplexing (OFDM) signals. In particular, this invention relates to methods for acquiring symbol timing and for acquiring system modes for OFDM schemes.

### BACKGROUND

Orthogonal frequency division multiplexing is a multi-carrier transmission technique that uses orthogonal subcarriers to transmit information within an available spectrum. Since the subcarriers may be orthogonal to one another, they may be spaced much more closely together within the available spectrum than, for example, the individual channels in a conventional frequency division multiplexing (FDM) system. Many modern digital communications systems are turning to the OFDM system as a modulation scheme for signals that need to survive in environments having multipath or strong interference, including the IEEE 802.11a standard, the Digital Video Broadcasting Terrestrial (DVB-T) standard, the Digital Video Broadcasting Handheld (DVB-H) standard, the Digital Audio Broadcast (DAB) standard, and the Digital Television Broadcast (T-DMB) standard.

In an OFDM system, the subcarriers may be modulated with a low-rate data stream before transmission. It is advantageous to transmit a number of low-rate data streams in parallel instead of a single high-rate stream since low symbol rate schemes suffer less from intersymbol interference (ISI) caused by the multipath.

In particular for DAB and T-DMB systems, OFDM signals can be transmitted in transmission frames, where each transmission frame consists of a number of symbols. The reception of these signals depends on successful acquisition of symbol timing and frame timing. Symbol timing acquisition can be accomplished by finding the boundary of each symbol; whereas frame timing acquisition can be accomplished by finding the starting symbol of each transmission frame.

The first symbol of each transmission frame is a NULL symbol, where no signal is sent. The NULL symbol is followed by a symbol with a known modulated sequence, such as a phase reference symbol (PRS). Since no signal is sent during the NULL symbol, the signal power measured at the NULL symbol is significantly lower than that at other symbols.

Traditional synchronization methods are based on using the NULL symbol for coarse time synchronization and for mode detection. Fine time synchronization uses the PRS for synchronization. This means that coarse symbol timing and frame timing are simultaneously determined by NULL symbol detection. However, a drawback of these methods is that a power measurement is not very accurate since the length of samples used in each power measurement is limited to the accuracy requirement in coarse symbol timing. Also, another drawback is that power-based NULL symbol detection without information on the symbol boundary is susceptible to fluctuation (e.g. channel fading or noise in the environment) in the received signal level.

Therefore, it is desirable to provide methods for acquiring system modes and for acquiring symbol timing before the NULL symbol detection, so that samples of a symbol can be used in each power measurement to provide more accurate power estimation.

### SUMMARY OF INVENTION

An object of this invention is to provide methods for mode detection and for acquiring coarse symbol timing by using cyclic prefix (CP) correlation.

Another object of this invention is to provide methods for improving mode detection and for acquiring coarse symbol timing by using samples spanning multiple OFDM symbols.

Yet another object of this invention is to provide methods for mode detection and for acquiring coarse symbol timing, where mode detection and acquiring of coarse symbol timing are performed before the NULL symbol detection.

Briefly, this invention relates to methods for determining coarse symbol timing and mode detection by using CP correlation-based techniques. In particular, the present invention relates to methods for determining symbol timing, frame timing, and system mode for signal acquisition, comprising the steps of: detecting symbol timing and system mode based on cyclic prefix correlation; and determining a null symbol as a function of a pre-defined number of consecutive symbols and using said null symbol to determine frame timing.

An advantage of this invention is that CP correlation can be used for mode detection and for acquiring coarse symbol timing.

Another advantage of this invention is that samples spanning multiple OFDM symbols can be used to improve mode detection and for acquiring coarse symbol timing.

Yet another advantage of this invention is that mode detection and acquiring coarse symbol timing are preformed before NULL symbol detection.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a frame structure used in OFDM transmissions.

FIG. 2 is a graph that illustrates the uncertainty in the derived symbol timing caused by using CP correlation.

FIGS. 3a-3b illustrate a process flow for mode detection and for acquiring symbol timing.

### DETAILED DESCRIPTION OF THE PREFERRED EMBODIMENTS

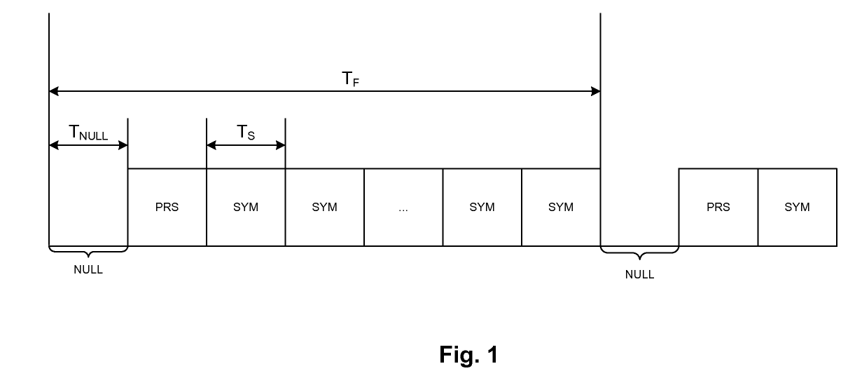

In OFDM schemes, the transmitted signal is modulated at each subcarrier in the frequency domain, where a fixed number of OFDM symbols are grouped to form a transmission frame. FIG. 1 illustrates a frame structure used in OFDM transmissions. No signal is sent during the NULL symbol period of duration T_{NULL}. The transmission duration of the frame is T_{F}.

The complex baseband representation of the signal is

$$\begin{matrix}s ( t ) = {\sum }_{m = - ∞}^{∞} {\sum }_{l = 0}^{L} {\sum }_{k = - K / 2}^{K / 2} {z}_{m , l , k} g ( t - {mT}_{F} - {T}_{NULL} - ( l - 1 ) {T}_{s} ) \\ where & ( 1 ) \\ {g}_{k , l} ( t ) = \{ \begin{matrix}0 & for l = 0 \\ {e}^{2 jπ k ( t - Δ ) / {T}_{U}} Re ct ( t / {T}_{s} ) & for l = 1 , 2 , … , L\end{matrix} & ( 2 )\end{matrix}$$

The variable, L, is the number of OFDM symbols in each transmission frame excluding the null symbol; K is the number of transmitted subcarriers; Δ is the guard interval (e.g. the cyclic prefix) for combating ISI; T_{U} is the inverse of subcarrier spacing; and Tₛ=T_{U}+Δis the OFDM symbol duration, excluding the NULL symbol. Subcarrier spacing is the signal bandwidth divided by the Fast Fourier Transform (FFT) size. Z_{m,l,k} is the DQPSK-modulated symbol at subcarrier k, of OFDM symbol l, in transmission frame m.

The demodulation of an OFDM symbol to reproduce Z_{m,l,k} is performed by first removing the cyclic prefix, and then applying an Inverse Fast Fourier Transform (IFFT) on the rest of the received OFDM symbol, which has duration T_{U}.

Preliminary signal acquisition and mode detection are achieved by exploiting the periodicity introduced by the CP. Different transmission modes are distinguished by the delay between the CP and the section of the signal that was copied to generate the CP. In particular for the T-DMB and the DAB standards, there are four modes, mode I, II, III, and IV.

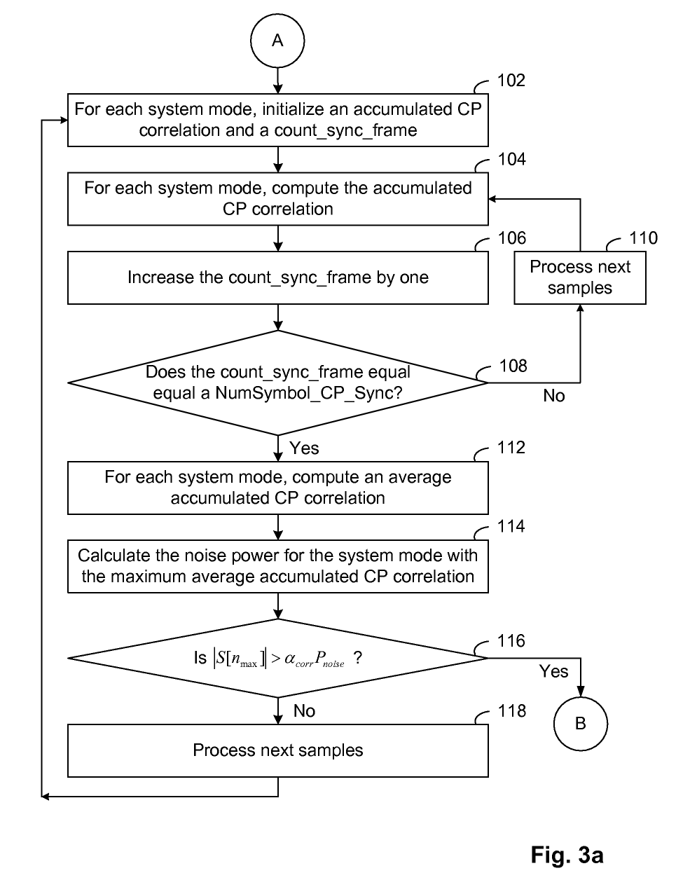

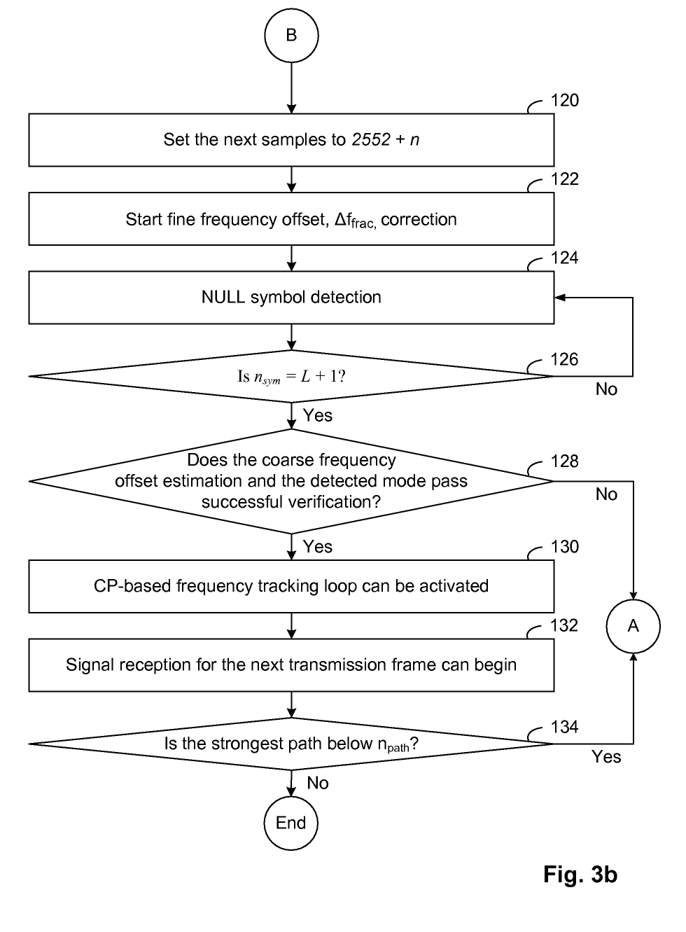

FIGS. 3a-3b illustrate a process flow for mode detection and for acquiring symbol timing. A received signal can be denoted, x[n], where a number of samples, for instance 2,552 samples, of the received signal can be processed together.

In the first step, for each possible system mode, the accumulated CP correlation can be initialized (102) by setting S[m]=0, where 0≦m≦FFTSize+CP−1. For system mode I/II/III/IV, FFTSize can be 2048, 512, 256, and 1024, respectively; and the CPs are 504, 126, 63, and 252, respectively. A variable denoted, count_sync_frame, can also be set to zero, count_sync_frame=0, during initialization.

Next, for each possible system mode, the accumulated cyclic prefix correlation can be computed (104),

$$S [ m mod ( F F T Size + CP ) ] = S [ m mod ( F F T Size + CP ) ] + {\sum }_{k = 0}^{CP - 1} x [ m - k ] {x}^{*} [ m - k - F F T Size ] \qquad ( 3 )$$

where 0≦m≦2551. The count_sync_frame variable can then be increased (106) by one, e.g. count_sync_frame+1.

If the count_sync_frame equals a NumSymbol_CP_Sync variable (108), then the average accumulated CP correlation values may be computed (112). Otherwise, the next 2,552 samples can be processed (110), and the accumulated cyclic prefix correlation for each possible system mode can be computed for the next samples (104). The NumSymbol_CP_Sync variable is a predefined integer for the purpose of improving acquisition accuracy. In the preferred embodiment of this invention, NumSymbol_CP_Sync can be set to 3.

The average accumulated CP correlation values over a defined moving window of a pre-determined length can be computed (112) in the following manner:

$$\overline{S} [ n ] = \frac{1}{SizeWinCPAverage} {\sum }_{i = - SizeWinCPAverage / 2}^{SizeWinCPAverage / 2 - 1} S [ n + i ] \qquad ( 4 )$$

where the variable, SizeWinCPAverage, is the size of the defined moving window. In the preferred embodiments of this invention, the SizeWinCPAverage can be set to 1, 2, or 4 for the purpose of reducing noise.

For the system mode with the maximum average accumulated CP correlation value, | S̅[n]| at nₘₐₓ, the noise power, Pₙₒᵢₛₑ, can be computed (114) as a function of nₘₐₓ. For instance, Pₙₒᵢₛₑ can be calculated in the following manner:

$${P}_{noise} = \frac{1}{b - a} {\sum }_{i = a}^{i = b - 1} \vert S [ ( {n}_{max} + i ) mod ( F F T Size + CP ) ] \vert \qquad ( 5 )$$

where FFTSize+CP≧b≧a≧0. In the preferred embodiment of the present invention, b is the FFTSize, and a is the CP.

If for any system mode |S[nₘₐₓ]|>α_{corr}Pₙₒᵢₛₑ, (116) where α_{corr} can be generally set to a large threshold value, such as 20, then symbol timing acquisition is successful with the corresponding system mode determined as the detected mode. If not, then the next 2552 samples are processed (118) and symbol timing acquisition can be restarted from the beginning, starting at initializing an accumulated CP correlation and a count_sync_frame (102).

For successful symbol timing acquisition and mode detection, the beginning of the next OFDM symbol (including cyclic prefix) can be set (120) to the next samples, 2552+n. With this, symbol timing synchronization is achieved. Next, the fine frequency offset, Δf_{frac}, can be computed by:

$$Δ {f}_{frac} = \frac{arg ( S [ {n}_{max} ] )}{2 π \cdot F F T Size \cdot T} \qquad ( 6 )$$

where T is the elementary period 1/2048000 second.

Frequency offset correction can begin (122) by first measuring the power, P, of the next symbol, where

$${P}_{0} = {\sum }_{k = CP}^{CP + F F T Size - 1} {\vert x [ n + k ] \vert}^{2} \qquad ( 7 )$$

Note that a few symbols may be discarded until the fine frequency offset correction settles down. Next, the symbol counter can be set to zero, n_{sym}=0, and the maximum power difference can be initialized to zero, pow_diff_max=0.

Next, NULL symbol detection can begin (124). For each consecutive symbol, n_{sym}, compute the power, Pₙ_{_{sym}}, averaged over the FFTSize samples.

If the following inequality in Equation (8) is true, then a possible NULL symbol is detected as symbol n_{sym}, and symbol n_{sym}+1 is saved as the corresponding possible PRS symbol.

5*log10(Pₙ_{_{sym}}Pₙ_{_{sym}}₋₂/P²ₙ_{_{sym}}⁻¹)>pow_diff_max (8)

Next, the symbol counter can be increased by a value of one, n_{sym}+1.

If the n_{sym} is equal to L plus one (126), e.g. n_{sym}=L+1, then verification of the coarse frequency offset estimation and mode verification can begin. Otherwise, NULL symbol detection (124) may keep searching for the NULL symbol.

After the NULL symbol is detected, coarse frequency offset estimation and mode verification are carried out using the saved PRS symbol (128). If verification succeeds, the initial estimate of carrier frequency offset can be Δf=Δf_{frac}+Δfᵢₙₜ, where Δfᵢₙₜ is the estimated coarse frequency offset. If verification fails, then mode detection and symbol timing acquisition may need to be restarted.

Several symbols for the updated frequency correction are processed until it settles down. A CP-based frequency tracking loop can be activated (130). Next, signal reception at the next transmission frame can begin (132). During PRS-based fine timing in the first transmission frame, if the strongest path is below ηₚₐₜₕ (134), then mode detection and symbol timing acquisition may need to be restarted. Otherwise, signal acquisition is complete.

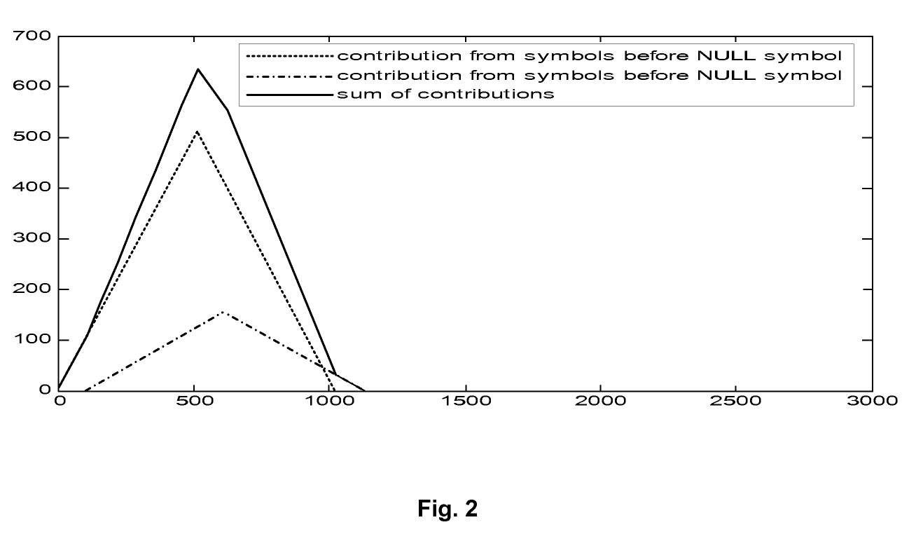

Note that the use of samples spanning multiple OFDM symbols is to accumulate CP correlation to reduce noise. Since the length of the NULL symbol is longer than a normal OFDM symbol, the presence of the NULL symbol in samples used to accumulate CP correlation will introduce some uncertainty in the derived symbol timing as shown in FIG. 2. Therefore, only FFTSize samples in the middle of each symbol is used for power measurement.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for determining symbol timing and frame timing for acquiring a signal, comprising the steps of:
detecting symbol timing based on cyclic prefix correlation; and
determining a null symbol as a function of a pre-defined number of consecutive symbols and using said null symbol to determine a frame timing for said signal.

2. The method of claim 1 wherein the determining null symbol step utilizes power measurement results of the pre-defined number of consecutive symbols.

3. The method of claim 1 wherein the pre-defined number of consecutive symbols is 3.

4. The method of claim 1 wherein the detecting step comprises the substeps of:
computing accumulated cyclic prefix correlation values over a pre-defined number of samples;
locating a maximum amplitude from the accumulated cyclic prefix correlation values, wherein the maximum amplitude is located at a particular location;
determining noise power; and
if for a given system mode maximum amplitude is greater than noise power times a pre-defined threshold, determining the symbol timing as a function of the location of the maximum amplitude and setting the system mode to equal to the given system mode.

5. The method of claim 1 wherein the determining null symbol step comprises the substeps of:
measuring a symbol power for each symbol as a function of the symbol timing;
determining a maximum power difference as a function of the one or more of the measured symbol power, wherein the maximum power difference is located at a particular location; and
detecting the null symbol as a function of the location of the maximum power difference.

6. The method of claim 5 wherein the measuring symbol power step is performed as a function of the symbol timing over a pre-defined number of symbols.

7. The method of claim 1 wherein a system mode is determined based on cyclic prefix correlation in the detecting symbol timing step.

8. The method of claim 5 wherein the determining null symbol step utilizes power measurement results of the pre-defined number of consecutive symbols.

9. The method of claim 5 wherein the pre-defined number of consecutive symbols is 3.

10. The method of claim 5 wherein the detecting step comprises the substeps of:
computing accumulated cyclic prefix correlation values over a pre-defined number of samples;
locating a maximum amplitude from the accumulated cyclic prefix correlation values, wherein the maximum amplitude is located at a particular location;
determining noise power; and
if for a given system mode maximum amplitude is greater than noise power times a pre-defined threshold, determining the symbol timing as a function of the location of the maximum amplitude and setting the system mode to equal to the given system mode.

11. A method for determining symbol timing and frame timing for acquiring a signal, comprising the steps of:
detecting symbol timing based on cyclic prefix correlation, having the substeps of:
computing accumulated cyclic prefix correlation values over a pre-defined number of samples;
locating a maximum amplitude from the accumulated cyclic prefix correlation values, wherein the maximum amplitude is located at a particular location;
determining noise power; and
if for a given system mode maximum amplitude is greater than noise power times a pre-defined threshold, determining the symbol timing as a function of the location of the maximum amplitude and setting the system mode to equal to the given system mode; and
determining a null symbol as a function of a pre-defined number of consecutive symbols and using said null symbol to determine a frame timing for said signal.

12. The method of claim 11 wherein the determining null symbol step utilizes power measurement results of the pre-defined number of consecutive symbols.

13. The method of claim 11 wherein the pre-defined number of consecutive symbols is 3.

14. The method of claim 11 wherein the determining null symbol step comprises the substeps of:
measuring a symbol power for each symbol as a function of the symbol timing over a pre-defined number of symbols;
determining a maximum power difference as a function of the one or more of the measured symbol power, wherein the maximum power difference is located at a particular location; and
detecting the null symbol as a function of the location of the maximum power difference.

15. The method of claim 14 wherein a system mode is determined based on cyclic prefix correlation in the detecting symbol timing step.

16. The method of claim 12 wherein a system mode is determined based on cyclic prefix correlation in the detecting symbol timing step.

17. A method for determining symbol timing and frame timing for acquiring a signal, comprising the steps of:
detecting symbol timing based on cyclic prefix correlation, having the substeps of:
computing accumulated cyclic prefix correlation values over a pre-defined number of samples;
locating a maximum amplitude from the accumulated cyclic prefix correlation values, wherein the maximum amplitude is located at a particular location;
determining noise power; and
if for a given system mode maximum amplitude is greater than noise power times a pre-defined threshold, determining the symbol timing as a function of the location of the maximum amplitude and setting the system mode to equal to the given system mode, wherein a system mode is determined based on cyclic prefix correlation in the detecting symbol timing step; and
determining a null symbol as a function of a pre-defined number of consecutive symbols by utilizing power measurement results of the pre-defined number of consecutive symbols, and using said null symbol to determine a frame timing for said signal, having the substeps of:
measuring a symbol power for each symbol as a function of the symbol timing over the pre-defined number of consecutive symbols;
determining a maximum power difference as a function of the one or more of the measured symbol power, wherein the maximum power difference is located at a particular location; and
detecting the null symbol as a function of the location of the maximum power difference.

18. The method of claim 17 wherein the pre-defined number of consecutive symbols is 3.
